(19) United States
(12) Patent Application Publication
(10) Pub. No.: US 2009/0300324 A1
(43) Pub. Date: Dec. 3, 2009

(54) ARRAY TYPE PROCESSOR AND DATA PROCESSING SYSTEM

(75) Inventor: Takeshi Inuo, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 12/448,809

(22) PCT Filed: Nov. 2, 2007
(86) PCT No.: PCT/JP2007/071386

§ 371 Date: Jul. 8, 2009

(30) Foreign Application Priority Data
Jan. 19, 2007 (JP) 2007-010352

(51) Int. Cl. G06F 9/30; G06F 9/46

(52) U.S. Cl. 712/17; 718/100; 712/E09.016

(57) ABSTRACT

In data path means, processor elements individually execute data processing in accordance with command codes described in a computer program, and switching elements individually control a connection relationship to switch among a plurality of processor elements in accordance with the command codes. When an access to an external memory is made from the data path means, slave memory means generates event data indicative of a task change while temporarily holding access information for executing the access with a delay, and executes the access in place of the data path means. Task changing means changes a task to be executed by the data path means when event data indicative of a task change is generated by the slave memory means.

### TECHNICAL FIELD

The present invention relates to a data processing apparatus which comprises array type processors, the configuration of which can be modified in hardware in accordance with software.

### BACKGROUND ART

At present, products referred to as so-called CPU (Central Processing Unit) and MPU (Micro Processor Unit) have been brought into operation as processor units which can freely execute a variety of data processing. In a data processing system which utilizes such a processor unit, a memory device stores a variety of object codes which describe a plurality of operation instructions, and a variety of processing data. A processor unit reads a plurality of operation instructions and processing data in order from the memory device, and sequentially executes data processing in line with the operation instructions. This type of data processing system can accomplish a variety of data processing with a single processor unit.

However, this type of data processing system sequentially executes a plurality of data processing in order. In this event, since the processor unit needs to read operation instructions from the memory device for each sequential processing operation, the system experiences difficulties in executing complicated data processing at high speeds.

On the other hand, when data processing to be executed is limited to one type of system so that the system is not required to have the ability to freely execute a variety of data processing, a logic circuit suitable for the execution of the data processing can be formed in hardware. In doing so, the processor unit need not read a plurality of operation instructions in order from the memory device to sequentially execute a plurality of data processing in order. For this reason, according to this configuration, complicated data processing can be executed at high speeds. In this configuration, however, executable data processing is limited to one type of data processing system, as a matter of course.

From the foregoing, a need exists for the realization of a data processing apparatus which is capable of executing a variety of data processing and moreover that is capable of performing the data processing at high speeds. And, for realizing this, a data processing apparatus having an array type processor has been proposed. The data processing apparatus comprises a plurality of processor elements in a processor unit, and can change the hardware configuration of the processor unit in accordance with software.

An array type processor comprises a data path unit which has a multiplicity of small-scaled processor elements and switching elements arranged in a matrix form, and a status managing unit disposed beside (juxtaposed to) this data path unit. A plurality of processor elements individually execute data processing in accordance with individually set operation instructions. A plurality of switching elements individually controls a connection relationship to switch among a plurality of processor elements in accordance with individually set operation instructions.

In this way, the array type processor can freely execute a variety of data processing because its hardware configuration is changed by switching operation instructions for a plurality of processor elements and a plurality of switching elements. Additionally, the array type processor can execute complicated data processing at high speeds as a whole because a multiplicity of small-scale processor elements, which is involved in hardware, execute simple data processing in parallel.

Then, the status managing unit sequentially switches contexts comprised of operation instructions for a plurality of processor elements and a plurality of switching elements as described above in accordance with object codes from one operation cycle to another. Accordingly, the array type processor can sequentially execute parallel processing in accordance with the object codes. Refer to Documents 1-8 shown below.

Document 1 (Japanese Patent No. 3269526)

Document 2 (JP-2000-138579A)

Document 3 (JP-2000-224025A)

Document 4 (JP-2000-232354A)

Document 5 (JP-2000-232162A)

Document 6 (JP-2003-076668A)

Document 7 (JP-2003-099409A)

Document 8 (“Introduction to the Configurable, Highly Parallel Computer,” authored by Lawrence Snyder, Purdue University, “IEEE Computer, vol. 15, No. 1, January 1982, pp 47-56”)

Further, a data processing system has been brought into operation, where a plurality of data processing apparatuses is connected in parallel to share complicated data processing. Such systems are classified into a homogeneous coupling type which connects a plurality of data processing apparatuses in the same structure, and a heterogeneous coupling type which connects a plurality of data processing apparatuses which differ in structure.

In a data processing system of the homogeneous coupling type, single data processing is shared by a plurality of data processing apparatuses in the same structure, so that the data processing can be executed with high parallelism. On the other hand, in a data processing system of the heterogeneous coupling type, single data processing is shared by a plurality of types of data processing apparatuses, so that each of the data processing apparatuses can be assigned to execute data processing that corresponding to its special strength. As a data processing system of the heterogeneous coupling type as described above, there is a hybrid system which is equipped with a mixture of a general MPU and an array type processor. Refer to Document 9 (International Publication WO2005/001689) by the present applicant.

In addition, a method has been known for appropriately generating object codes for this array type processor from source codes. Refer to Document 7. An object code, called herein, refers to contexts of the array type processor and codes for sequentially switching and operating the contexts from one operation cycle to another.

The present applicant has also proposed an array type processor which is capable of simulatively executing processing operations in parallel in accordance with a plurality of computer programs. Refer to Document 10 (JP-2005-222141A). The present applicant has further proposed an array type processor which is capable of executing operations corresponding to a computer program even if the computer program requires a data capacity which exceeds a storage capacity. Refer to Document 11 (JP-2005-222142A).

### DISCLOSURE OF THE INVENTION

When an array type processor as described above is actually used, all data are held in an external memory or the like connected to the array type processor through a system bus or the like, except for intermediate data which is temporarily held within the array type processor. Data held in the external memory or the like include data which should be processed by the array type processor, processed data, and a computer program which is an object code for the processing. A delay (read latency) occurs when the array type processor reads data from an external memory. As a result, a processor element waits for a response from the external memory for a longer time, resulting in a lower availability rate.

To prevent, for example, an approach relies on a burst access for accessing sequential addresses of a memory one after another. According to this approach, it is possible to mitigate the influence of a delay caused by read latency. However, the burst memory is not at all effective in random accesses to non-sequential addresses, though it is effective in accesses to sequential addresses.

Also, when an external memory desired for access is connected through a bus, the read latency varies depending on bus ownership acquisition and the like, and the read latency is often large. While an array type processor is waiting for a memory access, which involves an indefinite latency, to be completed (indefinite latency), other data processing which can be operated in parallel must be halted (stalled) in order to establish synchronization with the memory access. As a result, the availability rate of processor elements in the array type processor is often reduced significantly.

FIG. 1 is a state transition showing an example of a series of processing operations including an indefinite-latency memory read. Assume that there is a computer program which involves a series of processing operations including an indefinite-latency memory read, represented by the state transition as shown in FIG. 1. When this computer program is executed, the array type processor needs to wait for the indefinite-latency memory read to be completed in processing A3.

FIG. 2 is a time chart showing a sequential execution of the processing shown in FIG. 1. As can be understood from this figure, the array type processor executes only processing for waiting for the memory read at processing A3 to be completed at time T100, time T101, and time T102. Processing A4 can be executed when reading data of the memory is completed at time T103. In this way, the array type processor cannot execute other processing while it is waiting for a response of the indefinite-latency memory read. Consequently, processing performance is significantly degraded due to a lower availability rate of the processor elements.

It is an object of the present invention to provide an array type processor which improves the availability rate of processor elements in the array type processor.

To achieve the above object, an array type processor according to one aspect of the present invention is an array type processor for executing a computer program having a plurality of tasks, which comprises:

data path means including a plurality of processor elements and a plurality of switching elements arranged in a matrix form, wherein the processor elements individually execute data processing in accordance with instruction codes described in the computer program, and the switching elements individually switch and control a connection relationship among a plurality of the processor elements in accordance with the instruction codes;

slave memory means responsive to an access made from the data path means to an external memory for generating event data indicative of a task change while temporarily holding access information for executing an access with a delay, and executing the access in place of the data path means; and

task changing means for changing a task executed by the data path means when the event data indicative of a task change is generated in the slave memory means.

### BRIEF DESCRIPTION OF THE DRAWINGS

FIG. 1

A state transition showing an example of a series of processing operations including an indefinite-latency memory read.

FIG. 2

A time chart showing a sequential execution of processing shown in FIG. 1.

FIG. 3

A block diagram showing the configuration of data processing system 1000 according to an exemplary embodiment.

FIG. 4

A circuit configuration diagram showing the structure of a data path unit of an array type processor.

FIG. 5

A block diagram showing the configuration of a processor element and a switching element.

FIG. 6

A block diagram showing the configuration of a status managing unit and the data path unit.

FIG. 7

A block diagram showing the configuration of a task changeover unit.

FIG. 8

A block diagram showing the configuration of a slave memory unit.

FIG. 9A

A flow chart showing exemplary processing for describing the operation of the array type processor according to an exemplary embodiment.

FIG. 9B

A flow chart showing exemplary processing for describing the operation of the array type processor according to the exemplary embodiment.

FIG. 10

A time chart showing timing when the processing in FIGS. 9A, 9B is executed by the array type processor according to this exemplary embodiment.

FIG. 11

A block diagram showing another configuration of the slave memory unit.

### BEST MODE FOR CARRYING OUT THE INVENTION

A mode for carrying out the present invention will be described in detail with reference to the drawings.

### Configuration of Exemplary Embodiment

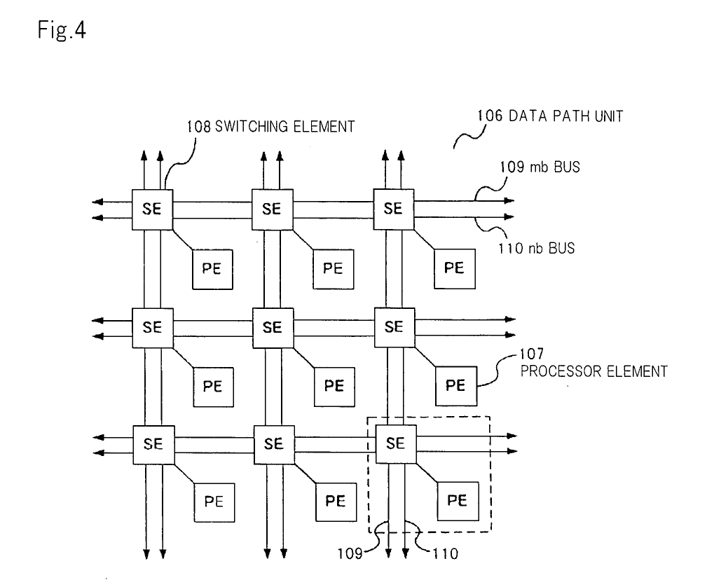

FIG. 3 is a block diagram showing the configuration of data processing system 1000 according to this exemplary embodiment. Referring to FIG. 3, data processing system 1000 comprises one array type processor 100 and one MPU 200 as a data processing apparatus. Array type processor 100 and MPU 200 are connected to each other through external bus 300 and data line 301.

Data processing system 1000 also comprises program memory 302 and program memory 303. Program memory 302 stores a computer program for array type processor 100. Program memory 303 stores a computer program for MPU 200. In this way, the memories are provided for storing the computer program exclusively for each of array type processor 100 and MPU 200. Then, program memory 302 and program memory 303 are connected to external bus 300.

Array type processor 100 reads its own computer program from program memory 302 and executes data processing in line with the computer program. In this event, input processing data is processed by and output from data path unit 106. Also, event data is issued by data path unit 106 in accordance with the data processing.

MPU 200 in turn comprises hardware (not shown) such as an interface (I/F) circuit, a processor core, an internal register and the like, and operates in line with the computer program stored in program memory 303. The operation of MPU 200 causes a variety of means such as data input means, data processing means, data storage means, data output means and the like to be logically formed as a variety of functions.

The data input means is analogous to a function of the processor core to recognize input data of the I/F circuit in line with a computer program. Data input to data input means includes processing data to be processed and event data. The data processing means is analogous to a function of the processor core for executing processing, and processes input processing data in line with the computer program and event data.

The data storage means is analogous to a function of the processor core to store processing data in the internal register, and temporarily stores a variety of data such as processing data. The data output means is analogous to a function of the processor core for controlling a data output of the I/F circuit, and outputs processed data and event data.

Note that MPU 200 of data processing system 1000 receives at least part of processing data and event data from array type processor 100, issues new event data corresponding to at least part of processing of the processing data, and outputs at least part of the processing data and the newly issued event data to array type processor 100.

Array type processor 100 comprises I/F circuit 101, processor core 102, memory controller 103, read multiplexer 104, and slave memory unit 180. Processor core 102 comprises status managing unit 105 and data path unit 106. Memory controller 103 is virtual recognition means, and is a circuit for issuing addresses. Read multiplexer 104 is a circuit for reading data.

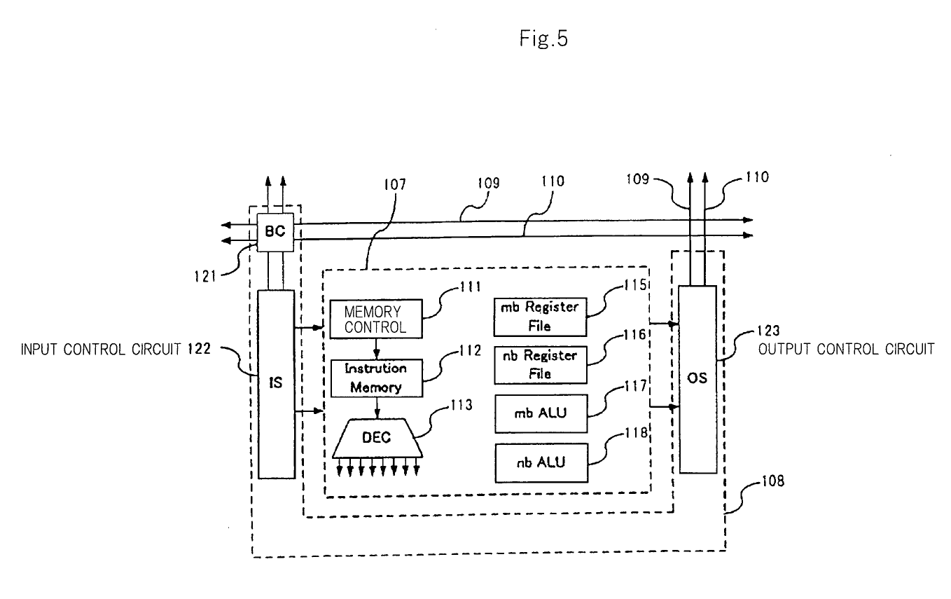

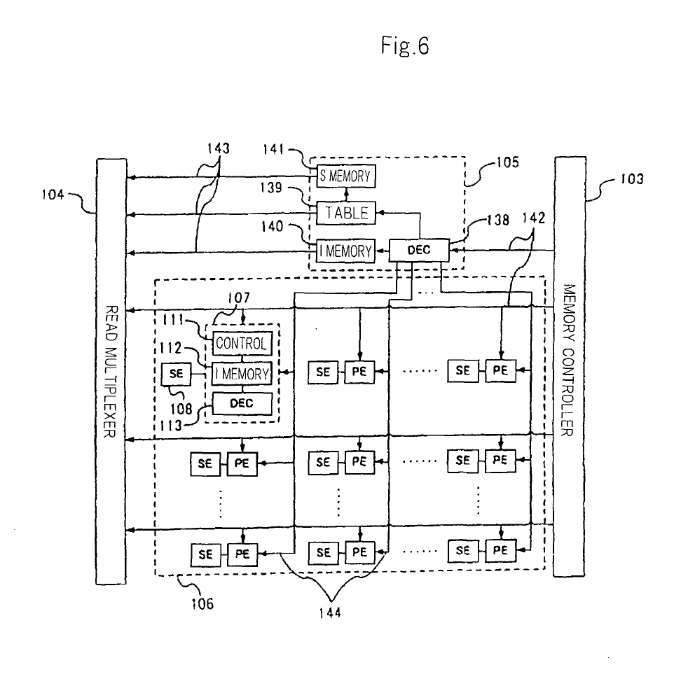

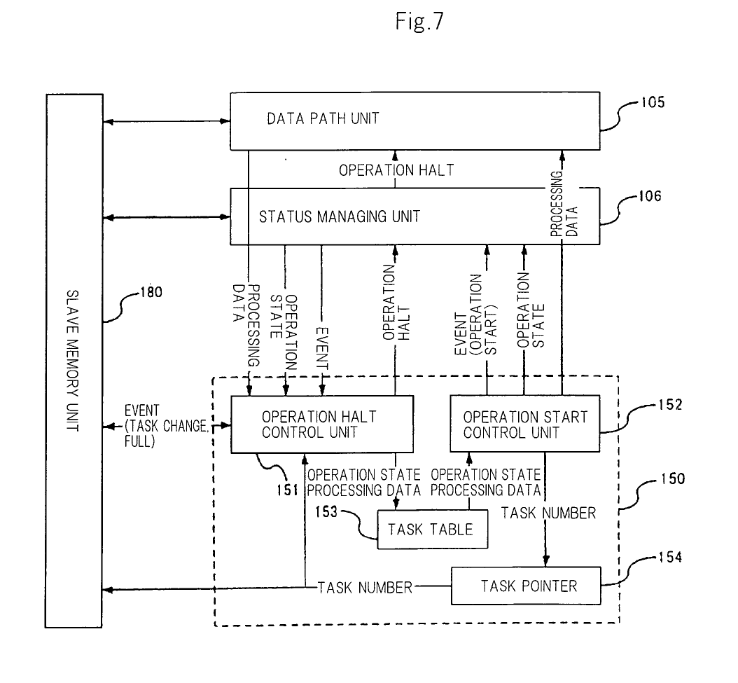

FIG. 4 is a circuit configuration diagram showing the structure of the data path unit in the array type processor. FIG. 5 is a block diagram showing the configuration of a processor element and a switching element. FIG. 6 is a block diagram showing the configuration of the status managing unit and data path unit.

As shown in FIGS. 4, 5, and 6, data path unit 106 comprises a plurality of processor elements 107, a plurality of switching elements 108, a plurality of mb (m-bit) buses 109, and a plurality of nb (n-bit) buses 110. As shown in FIG. 4, a plurality of processor elements (PE) 107 and a plurality of switching elements (SE) 108 are arranged in a matrix form, and are connected in a matrix form through a plurality of mb buses 109 and nb buses 110 . Mb buses 109 and nb buses 110 are part of a data bus.

Also, as shown in FIG. 5, each processor element 107 comprises memory control circuit 111, instruction memory 112, instruction decoder (DEC) 113, mb register file 115, nb register file 116, mb ALU (Arithmetic and Logical Unit) 117, nb ALU 118, and internal variable wires (not shown). Each switching element 108 comprises bus connector 121, input control circuit 122, and output control circuit 123. Instruction memory 112 is context storage means.

As shown in FIG. 3, I/F unit 101 comprises protocol control unit 131, task switching unit 150, memory access unit 132, and synchronizing control circuit 133. Protocol control unit 131, task switching unit 150, memory access unit 132, and synchronizing control circuit 133 are connected in series in this order. Further, protocol control unit 131 is connected to external bus 300. Memory access unit 132 in turn is connected to memory controller 103 and read multiplexer 104. Synchronizing control circuit 133 is connected to status managing unit 105 and data path unit 106 of processor core 102.

A bus protocol set to protocol control unit 131 is common to external bus 300, so that protocol control unit 131 communicates a variety of data with external bus 300 in line with this bus protocol. Also, protocol control unit 131 communicates a variety of data with memory access unit 132 through task switching unit 150 in a simpler approach.

As shown in FIG. 3, memory access unit 132 receives a variety of data inputs to protocol control unit 131 through external bus 300 from MPU 200, through task switching unit 150 from protocol control unit 131, and sends the data to memory controller 103, data path unit 106, and synchronizing control circuit 133. Memory access unit 132 also outputs a variety of data received from memory controller 103, data path unit 106, or synchronizing control circuit 133 through task switching unit 150 and from protocol control unit 131 by way of external bus 300 to MPU 200.

Synchronizing control circuit 133 receives event data input to protocol control unit 131 from MPU 200 through external bus 300, from memory access unit 132, and temporarily holds the event data. Also, synchronizing control circuit 133 temporarily holds event data input from status managing unit 105.

As shown in FIG. 3, event data input from MPU 200 to synchronizing control circuit 133 and temporarily held by synchronizing control circuit 133 is acquired by status managing unit 105 through data path unit 106. Event data input from status managing unit 105 to synchronizing control circuit 133 and temporarily held by synchronizing control circuit 133 is acquired by MPU 200.

Memory controller 103 sends a variety of data received from memory access unit 132 of I/F unit 101 to status managing unit 105 and data path unit 106 of processor core 102. Read multiplexer 104 reads data held by status managing unit 105 or data path unit 106 and sends the data to memory access unit 132.

Status managing unit 105 will be described in greater detail.

As shown in FIG. 6, status managing unit 105 comprises instruction decoder 138, transition table memory 139, instruction memory 140, and state memory 141. Instruction memory 140 is a memory for storing a transited status. Instruction decoder 138 is connected to memory controller 103 through instruction bus 142.

Instruction decoder 138 is connected to transition table memory 139 and instruction memory 140. Transition table memory 139 is connected to state memory 141.

As described above, read multiplexer 104 reads data held by status managing unit 105 and data path unit 106. For this purpose, a variety of memories 139-141 of status managing unit 105 are connected to read multiplexer 104 through data bus 143, and processor elements 107 and switching elements 108 of data path unit 106 are connected through mb data buses 109 and nb data buses 110.

As shown in FIG. 6, a plurality of processor elements 107 are arranged in X rows and Y columns (X and Y are natural numbers equal to or more than “2”). Then, instruction buses 142 for X lines connected in parallel from memory controller 103 to read multiplexer 104 are connected on a row-by-row basis to memory control circuits 111 of processor elements 107 in Y columns.

Further, address buses 144 of Y columns are connected to single instruction decoder 138 of status managing unit 105. Then, address buses 144 are connected on a column-by-column basis to memory control circuits 111 of processor elements 107 in X rows.

A computer program for array type processor 100 stored in program memory 302 describes instruction codes for a plurality of processor elements 107 and a plurality of switching elements 108 arranged in a matrix form in data path unit 106 as sequentially switching contexts. A context is comprised of instruction codes for each operation state of data path unit 106, and status managing unit 105 sequentially switches the contexts for respective operation states in accordance with instruction codes and event data from one operation state to another, and causes data path unit 106 to execute the contexts. Instruction codes for status managing unit 105 to switch the contexts from one operation state to another (every operation cycle) are described as operation states which transition in sequence. Also, a relative relationship among a plurality of sequentially transitioned operation states is described as a transition rule.

In status managing unit 105 having such a configuration, the computer program read from program memory 302 is decoded by instruction decoder 138. Decoded instruction codes are stored in instruction memory 140. Together, the transition rule for a plurality of operation states is stored in transition table memory 139.

Next, status managing unit 105 sequentially transitions operation states in accordance with the transition rule in transition table memory 139. Status managing unit 105 also generates each instruction pointer for a plurality of processor elements 107 and a plurality of switching elements 108 in line with the instruction codes in instruction memory 140.

In this regard, a current operation state is found from the transition rule temporarily held by transition table memory 139. The found current operation state is temporarily held in state memory 141. Also, instruction memory 140 stores a plurality of instruction codes corresponding to a plurality of operation states. For this purpose, a plurality of address data corresponding to the plurality of these instruction codes are sent from memory controller 103 to status managing unit 105.

An instruction code transmitted to status managing unit 105 through instruction bus 142 is also encoded with the address data of processor element 107 where the instruction code is to be stored. Instruction decoder 138 decodes the address data to select one signal line from address bus 144 having Y columns. The instruction code is sent to processor element 107 of one column connected to the signal line selected by instruction decoder 138.

Simultaneously with this, memory controller 103 selects one signal line from instruction bus 142 having X rows. In this way, when an instruction code is stored in instruction memory 112 of processor element 107, the instruction code and address data are sent to single processor element 107. As a result, the instruction code is stored in one address space in instruction memory 112 corresponding to the address data.

Switching element 108 shown in FIG. 5 shares instruction memory 112 of adjacent processor element 107. For this reason, status managing unit 105 supplies instruction memory 112 of corresponding processor element 107 with one set of instruction pointers generated for processor element 107 and switching element 108.

This instruction memory 112 temporarily holds instruction codes read from program memory 302 for processor element 107 and switching element 108. The instruction codes for processor element 107 and switching element 108 are specified by an instruction pointer supplied from status managing unit 105. Instruction decoder 113 decodes an instruction code specified by the instruction pointer, and controls the operation of switching element 108, internal variable wire, m/nb ALUs 117, 118, and the like in line therewith.

Mb bus 109 transmits “8 (bit),” indicated by mb, of processing data, while nb bus 110 transmits “1 (bit),” indicated by nb, of processing data. Switching element 108 controls a mutual connection relationship among a plurality of processor elements 107 through mb buses 109 and nb buses 110 in accordance with the operation control of instruction decoder 113.

More specifically, mb buses 109 and nb buses 110 are connected with one another in four directions in bus connector 121 of switching element 108, and switching element 108 controls a mutual connection relationship among the plurality of mb buses 109, and a mutual connection relationship among the plurality of nb buses 110.

With such a configuration, in array type processor 100, status managing unit 105 sequentially switches contexts of data path unit 106 from one operation cycle to another in accordance with the computer program set in program memory 302, and a plurality of processor elements 107 operate individually settable data processing operations in parallel at each stage.

As shown in FIG. 5, input control circuit 122 controls a connection relationship for data input from mb bus 109 to mb register file 115 and mb ALU 117, and a connection relationship for data input from nb bus 110 to nb register file 116 and nb ALU 118.

Output control circuit 123 controls a connection relationship for data output from mb register file 115 and mb ALU 117 to mb bus 109, and a connection relationship for data output from nb register file 116 and nb ALU 118 to nb bus 110.

The internal variable wires of processor element 107 control a connection relationship between mb register file 115 and mb ALU 117, and a connection relationship between nb register file 116 and nb ALU 118 within processor element 107 in accordance with the operation control of instruction decoder 113.

Mb register file 115 temporarily holds mb processing data inputted from mb buses 109 and the like according to the connection relationship controlled by the internal variable wires, and outputs the processing data to mb ALU 117 and the like. Nb register file 116 temporarily holds nb processing data input from nb bus 110 and the like according to the connection relationship controlled by the internal variable wires, and outputs the processing data to nb ALU 118 and the like.

Mb ALU 117 executes data processing in accordance with the operation control of instruction decoder 113 using the mb processing data. Nb ALU 118 executes data processing in accordance with the operation control of instruction decoder 113 using the nb processing data. In this way, m/nb data processing is executed as appropriate in correspondence to the number of bits of the processing data.

The result of the processing by this data path unit 106 is fed back to status managing unit 105 as event data if necessary. Status managing unit 105 makes a transition from one operation state to another operation state at the next stage in accordance with the input event data, and switches a context of data path unit 106 to a context at the next stage.

Array type processor 100 of this exemplary embodiment reads a computer program stored in program memory 302, and causes status managing unit 105 and data path unit 106 to hold instruction codes, as described above. Status managing unit 105 and data path unit 106 operate in line with the instruction codes. However, in data processing system 1000 of this exemplary embodiment, a plurality of computer programs is stored in program memory 302 for array type processor 100. Instruction codes for the plurality of computer programs are held in instruction memory 140 of status managing unit 105 and instruction memory 112 of data path unit 106.

Task changeover unit 150 comprises, for example, ASIC (Application Specific Integrated Circuit), and switches a plurality of computer programs held in instruction memories 140, 112 as appropriate. Each of computer programs held in instruction memories 140, 112 is referred to as a “task.”

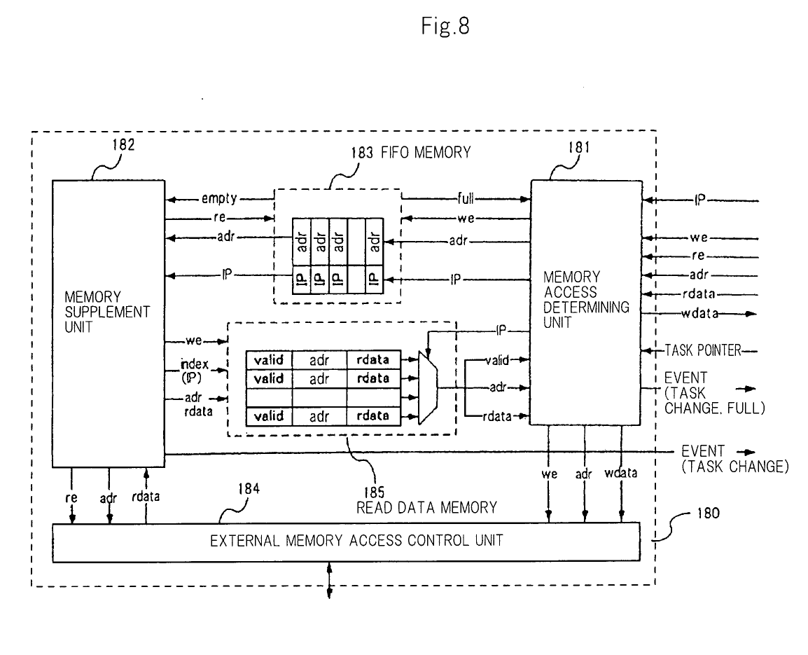

FIG. 7 is a block diagram showing the configuration of the task changeover unit. Referring to FIG. 7, task changeover unit 150 comprises operation halt control unit 151, operation start control unit 152, task table 153, and task pointer 154.

Task table 153 temporarily holds an intermediate state of processor core 102 such as the operation state of each of a plurality of tasks included in computer programs, processing data, and the like.

Operation halt control unit 151 controls halting a task. Operation halt control unit 151 receives a task change or a FULL event from status managing unit 105 or slave memory unit 180, and halts processor core 102 in response thereto. Then, operation halt control unit 151 temporarily records an intermediate state (operation state and processing data) of processor core 102 halted thereby in task table 153.

Task pointer 154 is a pointer indicative of a task which is currently executed by array type processor 100.

Operation start control unit 152 controls the operation start of a task. In this event, operation start control unit 152 selects an executable task from task table 153 to set the selected task in task pointer 154, acquires an intermediate state of processor core 102 from task table 153 to set the intermediate state in status managing unit 105 and data path unit 106, and thereafter outputs an operation start event to status managing unit 105.

In this regard, when processor core 102 is halted in response to an event, operation halt control unit 151 cannot change to another task in some cases depending on an event, such as FULL. Also, sometimes no executable task can be selected by operation start control unit 152. In such an event, task changeover unit 150 continuously halts the operation of processor core 102 until a task becomes executable.

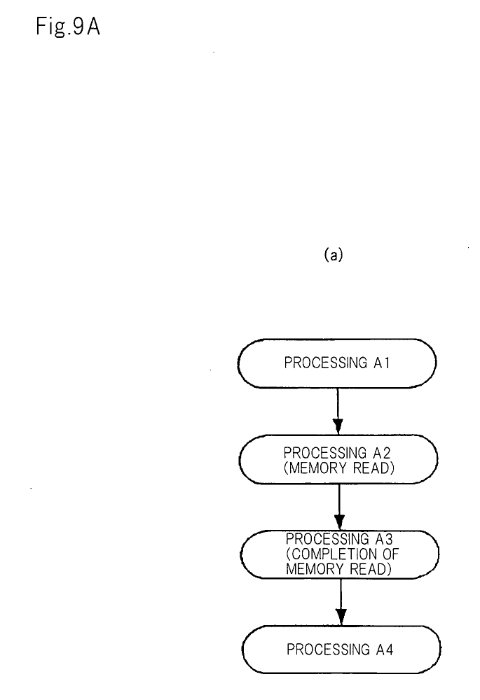

FIG. 8 is a block diagram showing the configuration of the slave memory unit.

Slave memory unit 180 comprises, for example, ASIC, and referring to FIG. 8, comprises memory access determining unit 181, memory supplement unit 182, FIFO memory 183, external memory access control unit 184, and read data memory 185.

Memory access determining unit 181 determines the type of an access, when made from processor core 102, and performs different processing depending on whether it is a read or a write access. In case of a memory write, memory access determining unit 181 immediately communicates this operation to external memory access control unit 180. In case of a memory read, memory access determining unit 181 determines whether or not an address at which a read is to be attempted matches an address of a data previously read out to read data memory 185, and performs different processing depending on whether or not they match. When they match, memory access determining unit 181 uses data in read data memory 185, whereas, when they do not match, memory access determining unit 181 instructs memory supplement unit 182 to read out (supplement) data to read data memory 185.

Memory supplement unit 182 reads data in external memory 190 by way of external memory access control unit 184 in response to an instruction from memory access determining unit 181, and writes the read data into read data memory 185. In this event, the instruction from memory access determining unit 181 is delayed by FIFO memory 183 before it is communicated to memory supplement unit 182.

FIFO memory 183 communicates addresses and the like of a memory to be supplemented, instructed from memory access determining unit 181, to memory supplement unit 182.

External memory access control unit 184 controls accesses to external memory 190 from memory access determining unit 181 or memory supplement unit 182.

Read data memory 185 temporarily holds data read by memory supplement unit 182 from external memory 190 through external memory access control unit 180. Data in read data memory 185 can be read from memory access determining unit 181.

As an operation of slave memory unit 180, when an access to external memory 190 is requested from data path unit 106 of processor core 102, memory access determining unit 181 determines the type of this memory access request. When a request to write data into memory is made, memory access determining unit 181 requests external memory access control unit 184 to execute the request as it.

When a request to read data from a memory is made, memory access determining unit 181 selects data from read data memory 185 with an instruction pointer, and determines whether or not the data is valid with reference to its VALID flag. As shown in FIG. 8, read data memory 185 records read data (rdata) read by memory supplement unit 182 together with an address (adr) and a VALID flag (valid). Each data in read data memory 185 can be selected by the instruction pointer (IP). The VALID flag indicates whether or not data is valid.

When the VALID flag is valid, memory access determining unit 181 determines whether or not an address requested from data path unit 160 matches a read address included in data read from read data memory 185.

When the VALID flag is valid, and when the address requested from data path unit 160 matches the read address included in the data read from read data memory 185, memory access determining unit 181 outputs the read data included in the data read from read data memory 185 to a data path, and changes the VALID flag of read data memory 185 to invalid.

When the VALID flag is invalid, or when the address requested from data path unit 160 does not match the read address included in the data read from read data memory 185, memory access determining unit 181 writes the address requested from data path unit 160 and an instruction pointer into FIFO memory 183, in order to request memory supplement unit 182 to read data from external memory 190, and outputs an event to task changeover unit 150 to indicate that the addresses do not match. In this event, if FIFO memory 183 is full (FULL), memory access determining unit 181 outputs a FULL event to task changeover unit 150 in a similar manner.

Memory supplement unit 182 monitors whether or not FIFO memory 183 is empty (EMPTY). When not empty, memory supplement unit 182 reads an instruction pointer and an address from FIFO memory 183, and reads data from external memory 190 at the address read from FIFO memory 183 by way of external memory access control unit 184.

Further, memory supplement unit 182 temporarily holds the read data in read data memory 185 together with the address. In this event, memory supplement unit 182 uses the instruction pointer read from FIFO memory 183 as a write index into read data memory 185. Also, memory supplement unit 182 writes the read data and address, and additionally writes “1” into the VALID flag. Next, memory supplement unit 182 outputs a task change event to task changeover unit 150.

External memory access unit 184 receives a request to write data into external memory 190 from memory access determining unit 181 or a request to read data from external memory 190 from memory supplement unit 182, and accesses external memory 190 through protocol control unit 131.

In this regard, when different tasks have the same instruction pointer, a task pointer may be added to an entry of FIFO memory 183 and to an entry of read data memory 185 for enabling the identification of the tasks. In this event, the task pointer may be acquired from task changeover unit 150.

### Operation of Exemplary Embodiment

In data processing system 1000 having the configuration as described above, MPU 200 functions as a main processor, while array type processor 100 functions as a co-processor, thus associating data processing of array type processor 100 with that of MPU 200.

In this event, array type processor 100 reads and executes its own computer program from program memory 302. MPU 200 in turn reads and executes its own computer program from program memory 303. Array type processor 100 and MPU 200 associate with each other, thus allowing data processing system 1000 to execute processing using data input from data line 301 and to output data of the processing result to data line 301.

The computer program of array type processor 100 describes instruction codes for a plurality of processor elements 107 and a plurality of switching elements 108 as sequentially switching contexts. Further, the computer program of array type processor 100 describes instruction codes for status managing unit 105, which switches the contexts from one operation cycle to another, as sequentially transitioned operation states.

In array type processor 100 which operates in line with such a computer program, status managing unit 105 sequentially transitions the operation state, and sequentially transitions the context of data path unit 106 from one operation cycle to another. Thus, a plurality of processor elements 107 operate in parallel through individually settable data processing from one operation cycle to another, and a plurality of switching elements 108 control the connection relationship to switch among the plurality of processor elements 107.

In this event, the processing result in data path unit 106 is fed back to status managing unit 105 as event data as required. Status managing unit 105 makes a transition from an operation state to an operation state at the next stage, and switches a context of data path unit 106 to a context at the next stage in accordance with the input event data.

As described above, array type processor 100 of this exemplary embodiment reads instruction codes from program memory 302, and temporarily holds the instruction codes in status managing unit 105 and data path unit 106. Status managing unit 105 and data path unit 106 operate in line with the operation codes.

However, in data processing system 1000 of this exemplary embodiment, a plurality of computer programs (tasks) are stored in program memory 302, and array type processor 100 reads and holds a plurality of computer programs. Then, each of the computer programs (tasks) executes data processing using data input through slave memory unit 180. However, if no data to be read exists in slave memory unit 180, array type processor 1000 temporarily halts the data processing, and switches to another operable task. Then, as the temporarily halted task is resumed to be executed through switching, the task resumes the operation from a memory read.

Since status managing unit 105, data path unit 106, and slave memory unit 180 operate in parallel through this series of operation controls, array type processor 100 is not degraded in its parallelism of data processing even while external memory 190 is being read.

The operation of data processing system 1000 will be described in greater detail.

Status managing unit 105 outputs a corresponding instruction pointer to data path unit 106 and slave memory unit 180 when it is executing a processing operation corresponding to one computer program.

On the other hand, data path unit 106 also executes a processing operation in line with the same computer program. Then, when external memory 190 is accessed during the execution, data path unit 106 outputs information such as the type of access, address, data and the like to slave memory unit 180.

Memory access determining unit 181 of slave memory unit 180 first determines the type of access when it is applied with the instruction pointer and memory access information. When the type of access is a memory write, memory access determining unit 181 requests external memory access control unit 184 for the memory access as it is.

When the type of access is a memory read, memory access determining unit 181 reads data from read data memory 185 using the instruction pointer as an index, and determines whether or not a VALID flag included in the data is valid.

When the VALID flag is valid, memory access determining unit 181 determines whether or not a read address included in the data read from read data memory 185 matches the address of the memory read requested from data path unit 106. When the VALID flag is valid, and when the read address included in the data read from read data memory 185 matches the address of the memory read from data path unit 106, memory access determining unit 181 outputs read data included in the data read from read data memory 185 to data path unit 106, and changes the VALID flag of the read data on read data memory 185 to invalid.

When the VALID flag is invalid in a memory read, or when the VALID flag is valid and the read address included in the data read from read data memory 185 does not match the address of the memory read requested from data path unit 106 in a memory read, memory access determining unit 181 outputs the address of the memory read requested from data path unit 106 and the instruction pointer to FIFO memory 183, and outputs a task change event to task changeover unit 150.

In this event, if FIFO memory 183 is FULL, memory access determining unit 181 outputs a FULL event to task changeover unit 150. This FULL event means that slave memory unit 180 has accepted a large amount of requests for memory reads and is therefore halted (stacked). In this state, status managing unit 105 and data path unit 106 cannot execute accesses to external memory 190 any more.

Memory supplement unit 182 monitors whether or not FIFO memory 183 is empty (EMPTY). When not empty, memory supplement unit 182 reads an instruction pointer and a read address of the memory from FIFO memory 183, and executes a read access to external memory 190 by way of external memory access control unit 184. Next, memory supplement unit 182 temporarily preserves the read data, read thereby, in read data memory 185 together with the address.

The instruction pointer read from FIFO memory 183 is used for a write index of read data memory 185. When the read data and address are written, memory supplement unit 182 writes “1” into the VALID flag. Further, memory supplement unit 182 outputs a task change event to task changeover unit 150.

External memory access unit 184 accesses external memory 190 through protocol control unit 131 in response to a write request from memory access determining unit 181 to external memory 190, or a read request from memory supplement unit 182 to external memory 190.

Upon receipt of the task change event from memory access determining unit 181 or memory supplement unit 182, task changeover unit 150 acquires an intermediate state (operation state and processing data) of a currently executed task from status managing unit 106 and data path unit 105, temporarily holds them in task table 153, and halts array type processor 100.

After array type processor 100 is halted, operation start control unit 152 selects an executable task with reference to task table 153. Further, operation start control unit 152 sets the task number of that task to task pointer 154, sets an intermediate state of the task in status managing unit 106 and data path unit 105, and then allows array type processor 100 to operate.

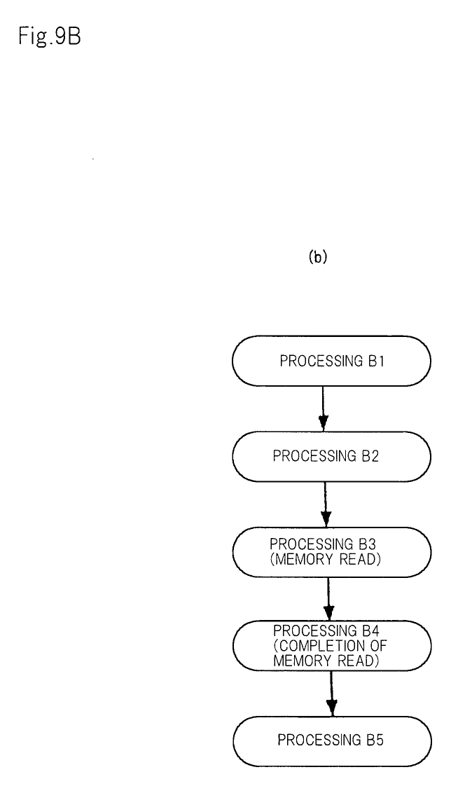

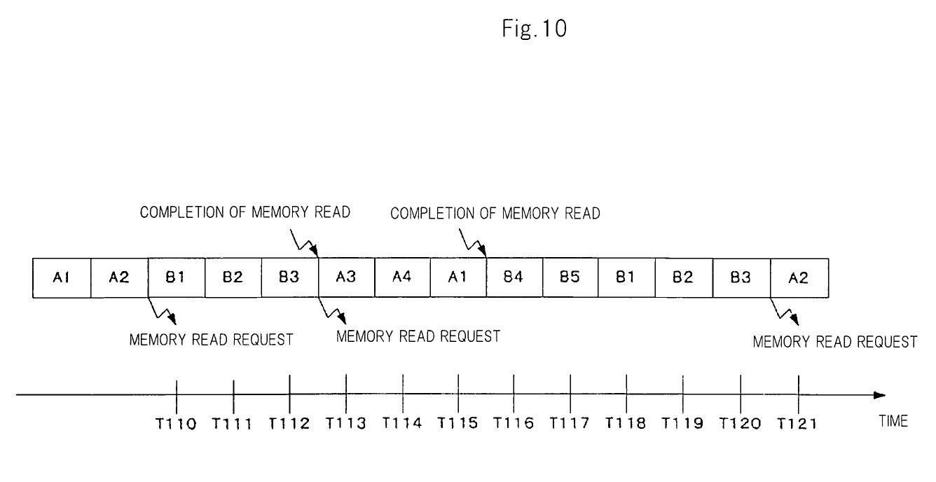

FIGS. 9A, 9B are flow charts showing exemplary processing for describing the operation of the array type processor according to this exemplary embodiment. FIG. 10 is a time chart showing timing when the processing of FIGS. 9A, 9B is executed by the array type processor according to this exemplary embodiment.

Assume that two sets of processing of task (a) shown in FIG. 9A and task (b) shown in FIG. 9B are executed by the array type processor according to this exemplary embodiment. Both the processing of task (a) and the processing of task (b) include a memory read.

At time T110, a task change occurs in response to a request for a memory read in processing A2 during the execution of task (a). In this event, when task (b) is executable, the execution of task (b) is started. Processing B1 of task (b) is executed at time T110, and processing B2 is executed at time T111, and processing B3 is executed at time T112. It is assumed that, in processing B3, a request for a memory read is made and the memory read for task (a) has been completed. Thus, a task change occurs at time T113. In this event, since task (a) is executable, task (a) is started from processing A3.

Processing A4 of task (a) is executed at time T114, and processing A1 is executed at time T115. Assume that in this event, the memory read for task (b) has been completed. Thus, a task change occurs at time T116. In this event, since task (b) is executable, task (b) is started from processing B4.

Processing B5, B1, B2, B3 are executed during times T117-T120. Here, a task change occurs in response to a request for a memory read of task (b). Since task (a) is executable, processing A2 of task (a) is executed at time T121.

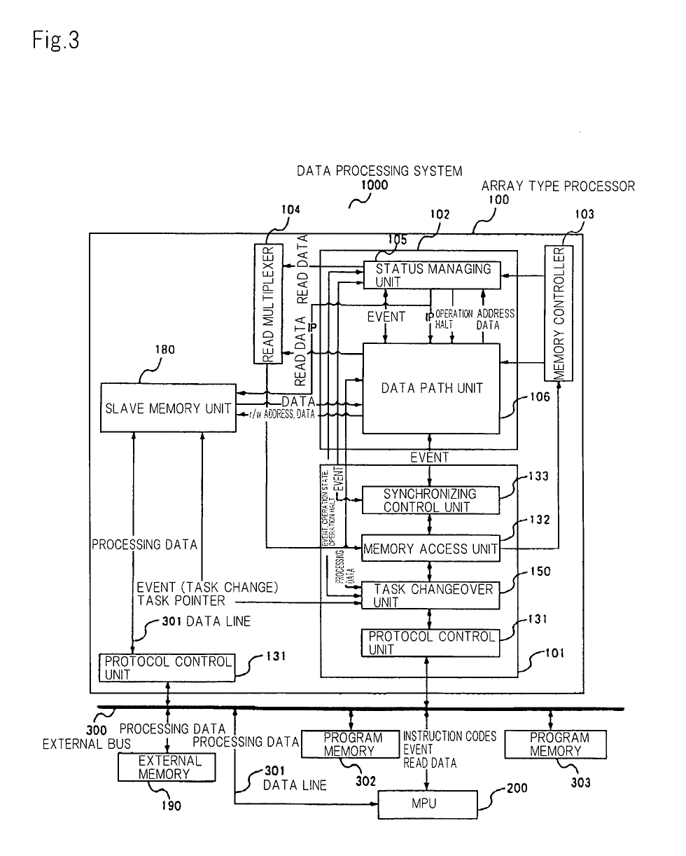

As can be understood from a comparison of the time chart of FIG. 10 with the time chart of FIG. 2, as array type processor 100 of this exemplary embodiment executes another task while it is waiting for a completion of memory read, array type processor 100 can reduce the time period in which the processing is suspended in order to wait for the completion of the memory read.

Since array type processor 100 of this exemplary embodiment performs the processing for waiting for a completion of a memory read in slave memory unit 180, the processing for waiting for the completion of the memory read need not be incorporated in a computer program. Accordingly, the processing operation of the computer program according to this exemplary embodiment can be implemented using a reduced amount of resources (processor elements 107 and switching elements 108).

Also, when task changeover unit 150 receives a FULL event from memory access determining unit 181, array type processor 100 halts the operation of status managing unit 105 and data path unit 106 until the FULL event is released. The FULL event indicates that more operations cannot be continued in status managing unit 105 and data path unit 106. This FULL event enables task changeover unit 150 to autonomously determine that array type processor 100 is inoperative. Then, by halting the operation of status managing unit 105 and data path unit 106 in synchronization with this FULL event, array type processor 100 can reduce power consumption by not performing unnecessary operations.

### Effects of Exemplary Embodiment

When array type processor 100 of this exemplary embodiment requests a read access to external memory 190 in operations of status managing unit 105 and data path unit 106, resulting from instruction codes set by a computer program, slave memory unit 180 performs operations associated with the read access, and in parallel with this, status managing unit 105 and data path unit 106 execute operations associated with instruction codes which are set by another computer program. Slave memory unit 180 executes an access to external memory 190 instead of data path unit 106, and task changeover unit 150 causes data path unit 106 to execute processing of another task in the meantime. Consequently, processor core 102 of array type processor 100 can operate even while it is waiting for a response from external memory 190, making it possible to improve the availability rate of the processor elements in the array type processor.

Moreover, in the computer program for array type processor 100, a random read for external memory 190, which involves an indefinite latency, can be treated as a fixed latency at all times.

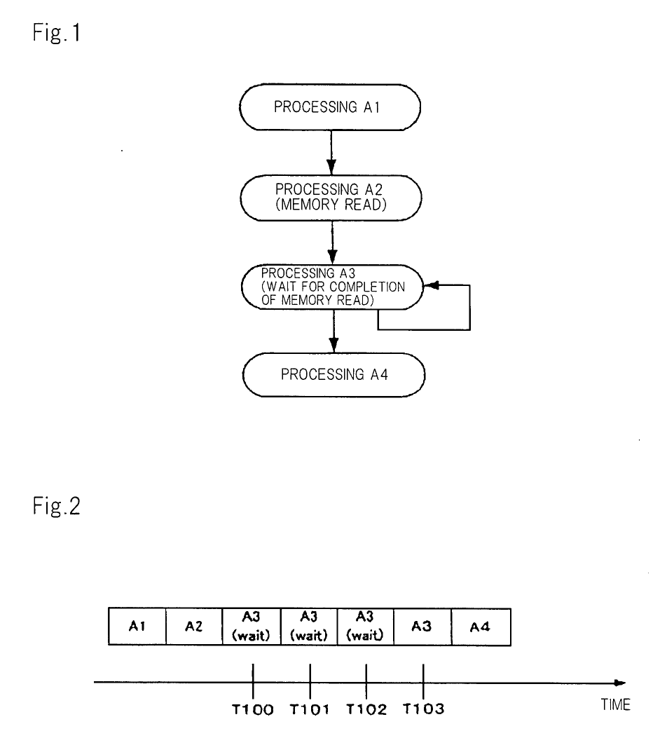

For performing a memory read with an indefinite latency as shown in FIG. 1, a circuit for waiting for an indefinite latency, and a circuit for stalling the processing are conventionally required in addition to a circuit for performing essential processing, which constitutes a factor causing an increase in the circuit scale of a data processing system. Also, when an object code of a conventional array type processor is generated from a source code, the object code must be additionally provided with scheduling for waiting for an indefinite latency, and scheduling for stalling the processing. As a result, a longer time is required to generate the object code. In this regard, since MPU is good at random accesses, random accesses tend to increase in a data processing system which comprises a mixture of an MPU and an array type processor and causes them to operate cooperatively together. As a result, random accesses tend to occur with high frequency in an array type processor which is mixed with an MPU.

In contrast to such a conventional array type processor, this exemplary embodiment does not have to cause status managing unit 105 and data path unit 106 to perform processing for waiting for the completion of a memory read as a computer program, so that its circuit and computer program can be simplified and implemented by using less resources (processor element 107 and switching element 108). Also, this can mitigate complicated operations of array type processor 100, and reduce a time for generating an object code from a source code.

Further, array type processor 100 of this exemplary embodiment determines whether or not the processing can be continued in status managing unit 105 and data path unit 106 in accordance with the FULL signal which is output when FIFO memory 183 for queuing read accesses to external memory 190 is full, and halts the operation of status managing unit 105 and data path unit 106 if the processing cannot be continued. Consequently, array type processor 100 can reduce unnecessary operations of status managing unit 105 and data path unit 106 to save power consumption.

### Modification Examples of Exemplary Embodiment

The present invention is not limited to the exemplary embodiment described above, but can be modified in various manners without departing from the spirit thereof.

For example, the foregoing exemplary embodiment has illustrated data processing system 1000 which comprises array type processor 100, MPU 200, and program memories 302, 303 connected through external bus 300. However, the data processing system of the present invention may be configured (not shown) such that array type processor 100 and program memory 302 are connected to outside 300 without program memories 302, 303.

Also, the foregoing exemplary embodiment has illustrated an example in which task changeover unit 150 is disposed between protocol control unit 131 and memory access unit 132. However, task changeover unit 150 of the present invention is only required to provide a function of switching tasks as mentioned above, and is not limited to be disposed between protocol control unit 131 and memory access unit 132.

Further, the foregoing exemplary embodiment has illustrated an example in which each component of task changeover unit 150 is configured in hardware as shown in FIG. 7. However, as another example, part or all of task changeover unit 150 of the present invention may be implemented by a combination of a microprocessor and software.

Also, the foregoing exemplary embodiment has illustrated an example in which slave memory unit 180 is disposed between data path unit 106 and protocol control unit 131. However, slave memory unit 180 of the present invention is only required to provide a function of accessing external memory 190, as described above, and is not limited to be disposed between data path unit 106 and protocol control unit 131.

Further, the foregoing exemplary embodiment has illustrated an example in which each component of slave memory unit 180 is configured in hardware as shown in FIG. 8. However, as another example, part or all of slave memory unit 180 may be implemented by a combination of a microprocessor and software.

Further, each component 151-154 of task changeover unit 150 or each component 181-185 of slave memory unit 180 may be partially or entirely implemented by MPU 200 which executes software programs.

When the function of task changeover unit 150 or slave memory unit 180 is implemented by MPU 200, the operating speed is inferior, as compared with that implemented in hardware. However, since task changeover unit 150 or slave memory unit 180 is implemented by a computer program of MPU 200 which is stored in program memory 303, the array type processor can advantageously be left unchanged in the hardware structure and readily implemented.

Further, each component 151-154 of task changeover unit 150 or each component 181-185 of slave memory unit 180 may be a dedicated circuit connected to array type processor 100 in part or in entirety. As a specific example, the dedicated circuit may be configured by an ASIC connected to external bus 300. Additionally, the dedicated circuit may be configured integrally with program memory 302 for array type processor 100.

Also, the foregoing exemplary embodiment has illustrated an example in which all instruction codes in a plurality of computer programs stored in program memory 302 are held by array type processor 100. Alternatively, array type processor 100 may hold only part of instruction codes of a plurality of computer programs stored in program memory 302. In this event, array type processor 100 may temporarily hold only a series of instruction codes required for processing operations, and may read instruction codes subsequent thereto from program memory 302 at a required timing.

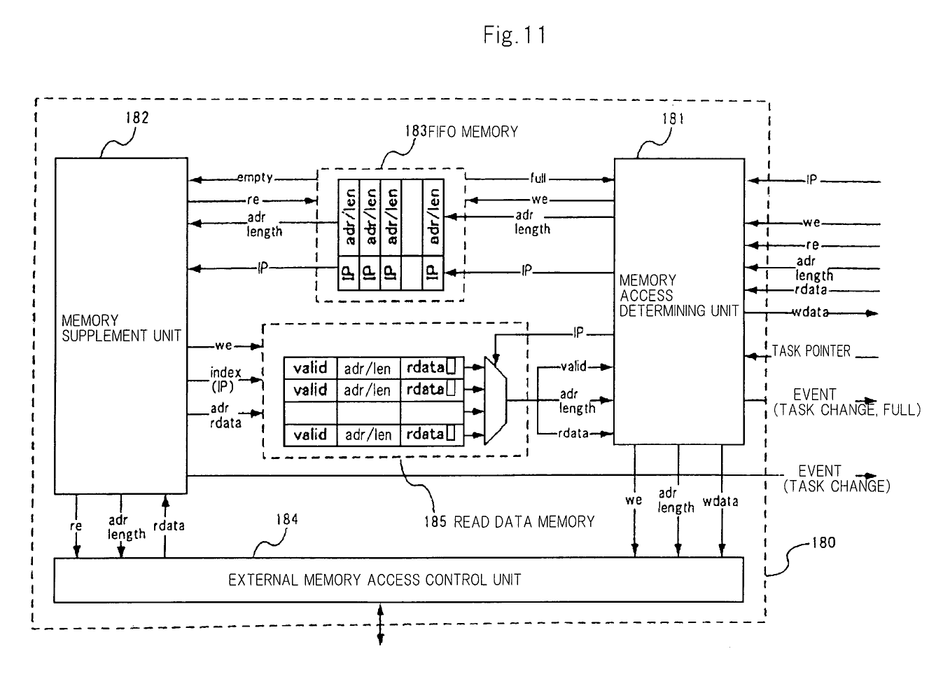

Also, the foregoing exemplary embodiment has shown the case where data path unit 106 accesses external memory 190 in units of single addresses. Alternatively, an access to external memory 190 may be a burst access in units of blocks. When an access to external memory 190 is a burst access in unit of blocks, slave memory unit 180 may be configured, for example, as shown in FIG. 11.

Referring to FIG. 11, a burst length (length) intended for a burst access is added as an input signal to data bus unit 180. Also, a burst length entry is added as contents stored in FIFO memory 183. In addition, read data memory 185 may be able to store read data at a depth taking into consideration the burst data.

Further, memory access determining unit 181, memory supplement unit 182, and external memory access unit 184 may respectively operate taking into consideration the burst length. For example, memory access determining unit 181 determines, upon memory read, whether or not a block to be read, indicated by an address and a burst length, has already been read out to read data memory 185. Data in read data memory 185 is used when it has been read, and memory supplement unit 182 is instructed to supplement data in read data memory 185 when it has not been read.

Also, the foregoing exemplary embodiment has illustrated the only the case of single slave memory unit 180. Alternatively, array type processor 100 may comprise a plurality of slave memory units 180. When there are a plurality of slave memory units 180, each of slave memory units 180 may be simplified in operation. For example, a slave memory unit dedicated to a write access to external memory 190 may be separated from a slave memory dedicated to a read access to external memory 190. In this way, each slave memory unit may be simplified in operation. Further, the slave memory unit dedicated for a write access and the slave memory dedicated to a read access may be configured only by components required for respective functions. In this way, the respective components can be simplified in configuration. Particularly, in the foregoing exemplary embodiment, since components required for a write access are only memory access determining unit 181 and external memory access control unit 184, the configuration of slave memory unit 180 dedicated to a read access produces a significant effect in simplification.

Also, the foregoing exemplary embodiment has shown an example in which memory access determining unit 181 immediately outputs data to external memory access control unit 184 when it determines a memory write, and external memory access control unit 184 outputs the data to external memory 190 in response thereto in a memory write operation into external memory 190. Slave memory unit 180 of the present invention, however, is not so limited. As another example, slave memory unit 180 may temporarily hold data to be written into external memory 190 and output the data to external memory 190 after it is delayed. In this event, a memory for temporarily holding the data may be provided, for example, within memory access determining unit 181, or may be provided within external memory access control unit 184. Further, slave memory unit 180 may previously give a priority to an access for each of memory reads and memory writes in the order of execution, such that a memory write is also delayed in addition to a memory read of external memory 190 to conduct priority control. In this way, processing efficiency can be improved through priority processing suited to a system or processing contents. For example, when the priority for a memory read is set higher than the priority for a memory write, the memory read can be improved in access latency.

Also, the foregoing exemplary embodiment has shown an example on the assumption that slave memory unit 180 and processor core 102 (state control unit 105 and data path unit 106) operate with synchronized clocks. The present invention, however, is not so limited. As another example, memory supplement unit 182 and external memory access control unit 184 of slave memory unit 180 may be operated with a different non-synchronized clock than that of processor core 102. Additionally, these clocks may not be fixed at certain rates but may be dynamically controlled. For example, the clock of slave memory unit 180 may be made faster when more accesses are made to external memory 190 by a computer program operated by processor core 102, while the clock of slave memory unit 180 may be made slower when less accesses are made to external memory 190. In this way, the power consumption of slave memory unit 180 can be reduced while preventing the processing performance as a whole from degrading due to accesses made to external memory 190 by slave memory unit 180, so that the power consumption of array type processor 100 can be reduced without degrading the performance thereof.

While the present invention has been described with reference to the exemplary embodiment, the present invention is not limited to the exemplary embodiment. The present invention as defined by the claims can be modified in configuration and details in various manners which can be understood by those skilled in the art within the scope of the invention.

The present application claims the benefit of the priority under Japanese Patent Application No. 2007-10352 filed Jan. 19, 2007, the disclosure of which is incorporated herein by reference in its entirety.

1. An array type processor for executing a computer program having a plurality of tasks, comprising:
data path unit including a plurality of processor elements and a plurality of switching elements arranged in a matrix form, wherein said processor elements individually execute data processing in accordance with instruction codes described in the computer program, and said switching elements individually switch and control a connection relationship among a plurality of said processor elements in accordance with the instruction codes;
slave memory unit that responsive to an access made from said data path unit to an external memory generates event data indicative of a task change while temporarily holding access information for executing an access with a delay, and executes the access in place of said data path unit; and
task changing unit that changes a task executed by said data path unit when the event data indicative of a task change is generated in said slave memory unit.

2. The array type processor according to claim 1, wherein when an access to an external memory is generated from said data path unit, said slave memory unit immediately executes the access if the access can be immediately executed, and generates the event data indicative of a task change while temporarily holding data of the access when the access cannot be immediately executed.

3. The array type processor according to claim 1, wherein:
said slave memory unit comprises memory access determining unit that determines the type of the access from said data path unit, a first-in first-out memory for temporarily holding access information of a memory read from said data path unit, memory supplementing unit that executes a memory read in line with access information output from said first-in first-out memory, and a read data memory for temporarily holding read data acquired by said memory supplementing unit through the memory read,
said memory access determining unit immediately executes the access from said data path unit when the access is a memory write; reads data at an accessed address from said read data memory and outputs the data to said data path unit when the access from said data path unit is a memory read and data on the address is held in said read data memory; and inputs access information on an access from said data path unit to said first-in first-out memory and generates event data indicative of the task change when the access is a memory read but data on an accessed address is not held in said read data memory, and
said memory supplementing unit executes a memory read to acquire read data and generates event data indicative of the task change.

4. The array type processor according to claim 1, further comprising:
state managing unit that manages operation states of said data path unit to sequentially transit contexts comprised of the instruction codes for each operation state from one to another of the operation states in accordance with the instruction codes and event data input thereto as appropriate,
wherein said data path unit executes data processing in line with the contexts which are sequentially transitioned from one to another of the operating states by said state managing unit.

5. The array type processor according to claim 4, wherein said slave memory unit generates event data indicative of a filled memory if access information of a memory read cannot be held in an attempt to temporarily hold the access information, and
when the event data indicative of a filled memory is generated by said slave memory unit, said task changing unit halts said data path unit and said state managing unit until the event data indicative of a filled memory is released.

6. The array type processor according to claim 4, wherein:
said task changing unit comprises:
operation halt control unit, responsive to event data indicative of a task change generated by said slave memory unit, halts operations of said state management unit and said data path unit, acquiring an operation state from said state management unit, and acquires processing data from said data path unit;
a task table for temporarily holding the operation state acquired from said state managing unit and the processing data acquired from said data path unit by said operation halt control unit on a task-by-task basis; and
operation start control unit that selects a task which can be executed by said state managing unit and said data path unit halted by said operation halt control unit from said task table, setting sets an operation state of the task temporarily held in said task table in said state managing unit, sets the processing data of the task in said data path unit, and starts operations of said state managing unit and said data path unit.

7. The array type processor according to claim 1, wherein said slave memory unit gives different priorities to a memory read and a memory write, temporarily holds access information of an access from said data path unit to said external memory irrespective of whether the access is a memory read or a memory write, and preferentially executes accesses from the one having the highest priority.

8. The array type processor according to claim 1, wherein said data path unit and said slave memory unit execute an access to said external memory in units of blocks.

9. The array type processor according to claim 1, comprising a plurality of said slave memory unit, wherein at least one slave memory unit is dedicated to a memory write.

10. The array type processor according to claim 1, wherein said slave memory unit, and said state control unit and data path unit operate on non-synchronized clocks with each other.

11. The array type processor according to claim 10, wherein said slave memory unit changes the rate of an operation clock in accordance with the frequency with which said external memory is accessed.

12. A data processing system comprising:
an array type processor for executing a computer program having a plurality of tasks, comprising data path unit including a plurality of processor elements and a plurality of switching elements arranged in a matrix form, wherein said processor elements individually execute data processing in accordance with instruction codes described in the computer program, and said switching elements individually switch and control a connection relationship among a plurality of said processor elements in accordance with the instruction codes; slave memory unit, responsive to an access made from said data path unit to an external memory, generates event data indicative of a task change while temporarily holding access information for executing an access with a delay, and executes the access in place of said data path unit; and task changing unit for changing a task executed by said data path unit when the event data indicative of a task change is generated in said slave memory unit; and
a program memory which has stored therein the computer program executed by said array type processor.
